(19) United States
(12) Patent Application Publication
(10) Pub. No.: US 2012/0195031 A1
(43) Pub. Date: Aug. 2, 2012

(54) FLASHLIGHT FOR CAR RE-CHARGER

(76) Inventor: Hsi To LI, Taipei City (TW)

(21) Appl. No.: 13/018,306

(22) Filed: Jan. 31, 2011

(51) Int. Cl. F21L 4/08

(52) U.S. Cl. 362/183

(57) ABSTRACT

A flashlight for car re-charger includes a flashlight body. The flashlight body has a head mounted a front end thereof and a connecting portion disposed a rear end thereof. A flexible extender is electrically and detachably connected with the flashlight body. A charging plug is electrically connected with the flexible extender for charging the flashlight body. A magnet connector is detachably sleeved on charging plug for providing a magnetic effect.

### BACKGROUND OF THE INVENTION

1. Field of the Invention

The present invention relates to a flashlight, and more particularly to a flashlight for car re-charger.

2. Description of Related Art

A conventional portable flashlight includes a head connected with a body, a switch disposed on the body for actuating the flashlight, and a plurality of batteries mounted in the body for providing power source. However, the conventional portable flashlight is depended on the power of the batteries. It is very inconvenient when the batteries power is consumed.

Another conventional portable flashlight includes a head connected with a body, a switch disposed on the body for actuating the flashlight, a plurality of batteries mounted in the body for providing power source, and a manual re-charger mounted on the body for charging the power of the batteries. However, the conventional portable flashlight is recharged by human hand's operation. It is still inconvenient to operate the re-charger when driving vehicle. Especially, mobile vehicle already has a lot of electrical power for charge the batteries of the conventional portable flashlight, but there is no such a device to supply the power to the conventional portable flashlight.

The present invention has arisen to mitigate and/or obviate the disadvantages of the conventional flashlight.

### SUMMARY OF THE INVENTION

The main objective of the present invention is to provide an improved flashlight, and more particular to a flashlight for car re-charger.

To achieve the objective, the flashlight for car re-charger in accordance with the present invention includes a flashlight body. The flashlight body has a head mounted a front end thereof for proving illuminative effect and a connecting portion disposed a rear end thereof A flexible extender is electrically connected with the flashlight body. The flexible extender is freely bendable and has a tubular structure. The flexible extender has one end detachably assembled with the connecting portion of the flashlight body. A charging plug is electrically connected with the other end of the flexible extender for charging the flashlight body. The charging plug is adapted to be inserted into a car re-charger which is positioned in a cigarette lighter. A magnet connector is detachably sleeved on charging plug for providing a magnetic effect such that the charging plug, the flexible extender, and the flashlight body are able to magnetically attach on a metallic place.

The flashlight body is able to freely illuminate toward any direction due to a flexibility of the flexible extender. The flashlight body is also utilized alone as a normal flashlight. The charging plug is adapted to provide an electrical power in the car to charge the flashlight body. The charging plug is also adapted to provide for disconnecting to the car re-charger when the flashlight body is fully charged. The magnet connector is provided for attaching the flashlight body including the charging plug and the flexible extender on a favorite metallic place.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a flashlight for car re-charger in accordance with the present invention;

FIG. 2 is a partial exploded perspective view of the flashlight for car re-charger in accordance with the present invention; and

FIGS. 3-5 are operational views of the flashlight for car re-charger in accordance with the present invention.

### DETAILED DESCRIPTION OF THE INVENTION

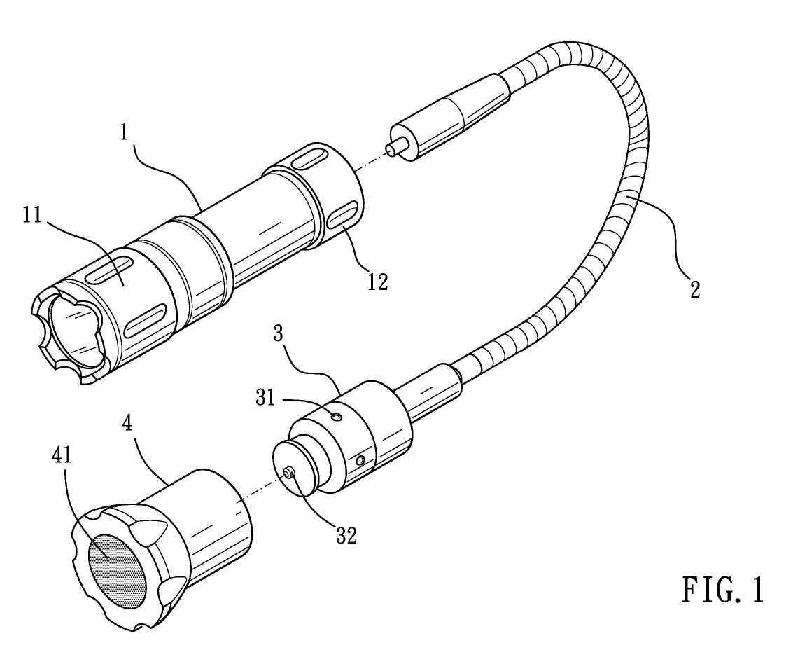

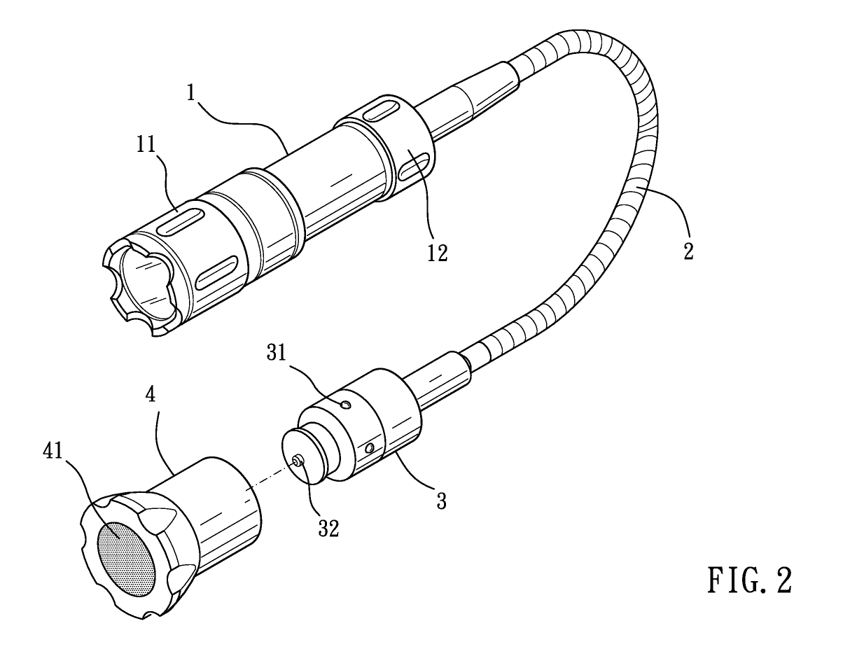

Referring to the drawings and initially to FIGS. 1-6, a flashlight for car re-charger in accordance with the present invention comprises a flashlight body 1, a flexible extender 2 electrically connected with the flashlight body 1, a charging plug 3 electrically connected with the flashlight body 1, and a magnetic connector 4 mounted on the charging plug 3.

The flashlight body 1 has a head 11 mounted a front end thereof for proving illuminative effect and a connecting portion 12 disposed a rear end thereof A plurality of batteries (not shown) are mounted in the flashlight body 1.

The flexible extender 2 is freely bendable. The flexible extender 2 has a tubular structure for receiving a wire (not shown) connecting the charging plug 3 and the flashlight body 1. The flexible extender 2 has one end detachably assembled with the connecting portion 12 of the flashlight body 1.

The charging plug 3 is electrically connected with the other end of the flexible extender 2 for charging the batteries in the flashlight body 1. The charging plug 3 is adapted to be inserted into a car re-charger which is positioned in a cigarette lighter.

The charging plug 3 has a cylinder structure. The charging plug 3 has a plurality of balls 31 annularly and compressibly mounted on an outer periphery thereof and an inserter 32 compressibly mounted on a distal end thereof The balls 31 and the inserter 32 are provided for stably assembling with the car re-charger in the cigarette lighter.

The magnet connector 4 is detachably sleeved on charging plug 3 for providing a magnetic effect such that the charging plug 3, the flexible extender 2, and the flashlight body 1 are able to magnetically attach on a metallic place.

The flexible extender 2 is freely bendable such that the flashlight body 1 is able to freely illuminate toward any direction due to a flexibility of the flexible extender 2. The flexible extender 2 is able to detach from the flashlight body 1 such that the flashlight body 1 is utilized alone as a normal flashlight.

The charging plug 3 is able to provide an electrical power in the car to charge the flashlight body 1. The charging plug 3 is also adapted to provide for disconnecting to the car re-charger when the flashlight body 1 is fully charged. The magnet connector 4 is provided for attaching the flashlight body 1 including the charging plug 3 and the flexible extender 2 on a favorite metallic place.

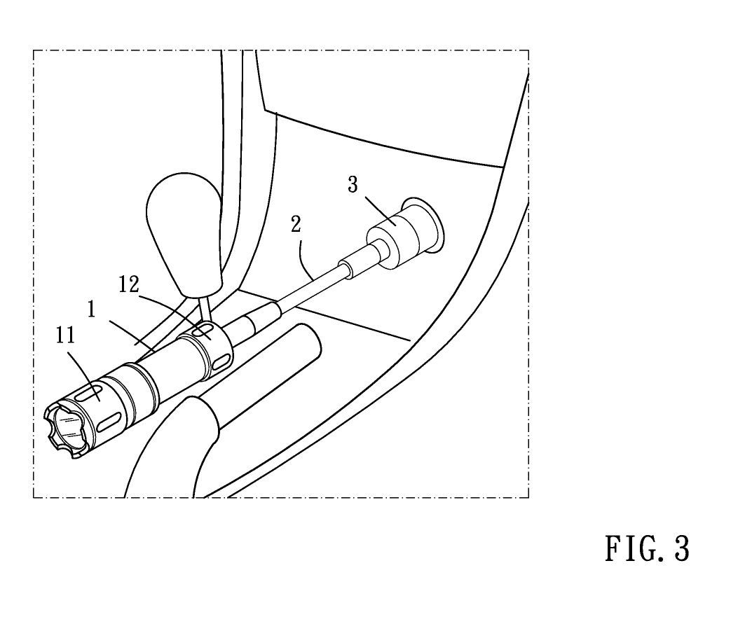

Referring to FIG. 3, the charging plug 3 is inserted into the car re-charger in the cigarette lighter. The inserter 32 is assembled with the re-charger and the balls 31 of the charging plug 3 are provided for fixing the charging plug 3 in the re-charger, such that the electrical power is transported from the re-charger via the charging plug 3 and the flexible extender 2 into the batteries in the flashlight body 1. Therefore, the flashlight body 1 is charged.

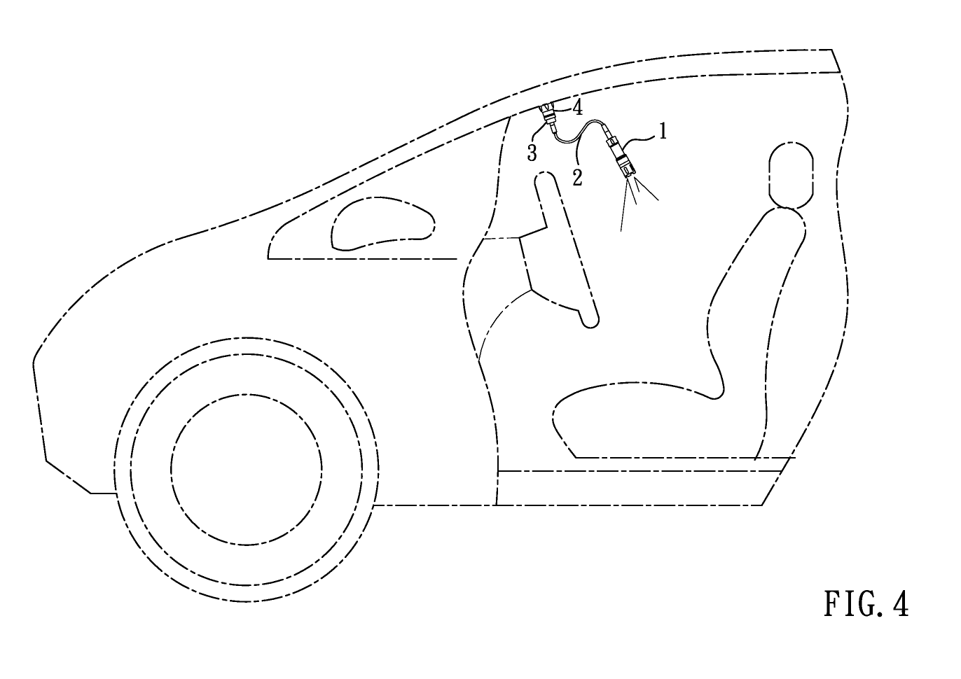

Referring to FIG. 4, the magnet 41 in the magnet connecter 4 is provided for magnetically attached the flexible extender 2 with the flashlight body 1 on the metallic place in the car. The magnet connecter 4 is also easily detached such that a user can easily change a location of the flashlight body 1. Therefore, the flashlight body 1 can provide lights to the user for reading in the car or illuminating a dark place.

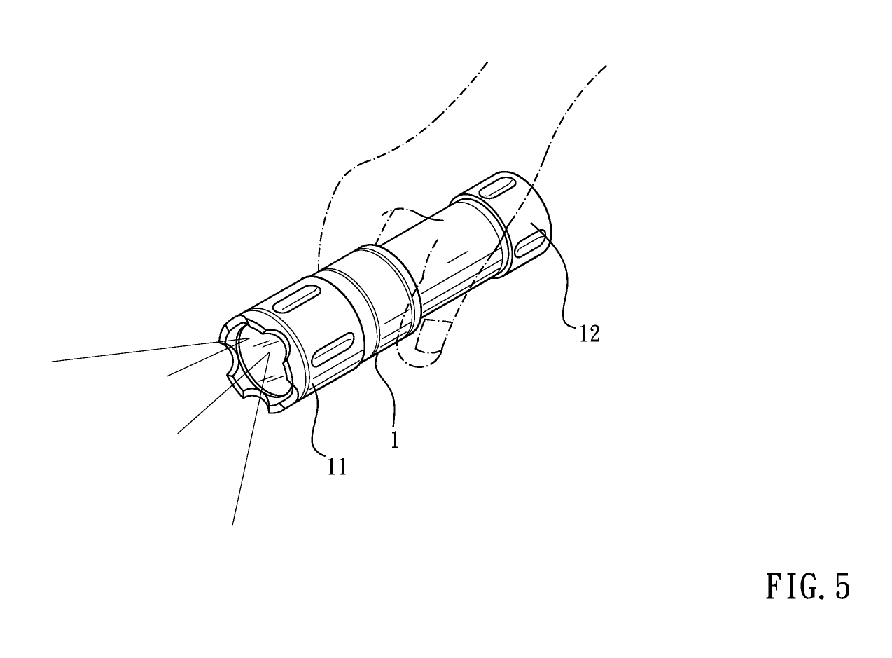

Referring to FIG. 5, the flashlight body 1 is detached from the flexible extender 2 and is singly utilized as a normal flashlight for providing illumination. The user can easily charge the flashlight body 1 via the charging plug 3. There is necessary to worry about the power of the flashlight body 1.

Although the invention has been explained in relation to its preferred embodiment, it is to be understood that many other possible modifications and variations can be made without departing from the spirit and scope of the invention as hereinafter claimed.

What is claimed is:

1. A flashlight for car re-charger, comprising:
a flashlight body, the flashlight body having a head mounted a front end thereof for proving illuminative effect and a connecting portion disposed a rear end thereof;
a flexible extender electrically connected with the flashlight body, the flexible extender being freely bendable and having a tubular structure, the flexible extender having one end detachably assembled with the connecting portion of the flashlight body; and
a charging plug electrically connected with the other end of the flexible extender for charging the flashlight body, the charging plug adapted to be inserted into a car re-charger which is positioned in a cigarette lighter;
wherein the flashlight body is able to freely illuminate toward any direction due to a flexibility of the flexible extender, the flashlight body is also utilized alone as a normal flashlight, the charging plug is adapted to provide an electrical power in the car to charge the flashlight body, the charging plug is also adapted to provide for disconnecting to the car re-charger when the flashlight body is fully charged.

2. A flashlight for car re-charger, comprising:
a flashlight body, the flashlight body having a head mounted a front end thereof for proving illuminative effect and a connecting portion disposed a rear end thereof;
a flexible extender electrically connected with the flashlight body, the flexible extender being freely bendable and having a tubular structure, the flexible extender having one end detachably assembled with the connecting portion of the flashlight body; and
a magnet connector connected with the other end of the flexible extender for providing a magnetic effect such that the flexible extender with the flashlight body is able to magnetically attach on a metallic place;
wherein the flashlight body is able to freely illuminate toward any direction due to a flexibility of the flexible extender, the flashlight body is also utilized alone as a normal flashlight, the magnet connector is provided for attaching the flexible extender with the flashlight body on a favorite metallic place.

3. A flashlight for car re-charger, comprising:
a flashlight body, the flashlight body having a head mounted a front end thereof for proving illuminative effect and a connecting portion disposed a rear end thereof;
a flexible extender electrically connected with the flashlight body, the flexible extender being freely bendable and having a tubular structure, the flexible extender having one end detachably assembled with the connecting portion of the flashlight body;
a charging plug electrically connected with the other end of the flexible extender for charging the flashlight body, the charging plug adapted to be inserted into a car re-charger which is positioned in a cigarette lighter; and
a magnet connector detachably sleeved on charging plug for providing a magnetic effect such that the charging plug, the flexible extender, and the flashlight body are able to magnetically attach on a metallic place;
wherein the flashlight body is able to freely illuminate toward any direction due to a flexibility of the flexible extender, the flashlight body is also utilized alone as a normal flashlight, the charging plug is adapted to provide an electrical power in the car to charge the flashlight body, the charging plug is also adapted to provide for disconnecting to the car re-charger when the flashlight body is fully charged, the magnet connector is provided for attaching the flashlight body including the charging plug and the flexible extender on a favorite metallic place.
